(19) United States
(12) Patent Application Publication
(10) Pub. No.: US 2026/0298883 A1
(43) Pub. Date: Oct. 1, 2026

(54) COMPRESSIVE SENSING FOR PHASED-ARRAY ACOUSTIC INSPECTION

(71) Applicant: Evident Canada, Inc., Québec (CA)

(72) Inventor: Alain Le Duff, Quebec (CA)

(21) Appl. No.: 19/479,058

(22) PCT Filed: Apr. 26, 2024
(86) PCT No.: PCT/CA2024/050553

§ 371 Date: Oct. 27, 2025

Related U.S. Application Data
(60) Provisional application No. 63/499,070, filed on Apr. 28, 2023.

(51) Int. Cl. G01N 29/26; G01N 29/04; G01N 29/06; G01N 29/44

(52) U.S. Cl. CPC G01N 29/262; G01N 29/043; G01N 29/069; G01N 29/44; G01N 2291/106

(57) ABSTRACT

A compressive sensing-based technique can be used to reduce a count of channels needed to collect analog signals from a multi-element PAUT probe, such as with a Plane Wave Imaging (PWI) acquisition approach where multiple elements are excited contemporaneously for transmission. Such an approach makes it possible to considerably simplify the hardware architecture of instrumentation, such as reducing complexity of wiring of the probe assembly or related interconnects. A portion or an entirety of an analog front end (AFE) can be embedded in the probe itself. Use of the present teachings can include reconstruction of received signals corresponding to the individual elements of the probe, with as few as a single analog channel used for receiving. As an example, as few as a single pulser can be used in transmission and as few as single analog-to-digital converter (ADC) can be used in reception.

### CLAIM OF PRIORITY

This patent application claims the benefit of priority of Alain Le Duff, U.S. Provisional Patent Application No. 63/499,070, titled “PHASED ARRAY ULTRASONIC TESTING (PAUT) PROBE,” filed on Apr. 28, 2023 (Attorney Docket No. 6409.242PRV), which is hereby incorporated by reference herein in its entirety.

### FIELD OF THE DISCLOSURE

This document pertains generally, but not by way of limitation, to non-destructive evaluation, and more particularly, to apparatus and techniques a phased array ultrasonic transducer (PAUT) probe configuration that can include as few as a single electrical measurement channel serving multiple transducer elements.

### BACKGROUND

Non-destructive testing (NDT) can refer to use of one or more different techniques to inspect regions on or within an object, such as to ascertain whether flaws or defects exist, or to otherwise characterize the object being inspected. Examples of non-destructive test approaches can include use of an eddy-current testing approach where electromagnetic energy is applied to the object and resulting induced currents on or within the object are detected, with the values of a detected current (or a related impedance) providing an indication of the structure of the object under test, such as to indicate a presence of a crack, void, porosity, or other inhomogeneity.

Another approach for NDT can include use of an acoustic inspection technique, such as where one or more electroacoustic transducers are used to insonify a region on or within the object under test, and acoustic energy that is scattered or reflected can be detected and processed. Such scattered or reflected energy can be referred to as an acoustic echo signal. Generally, such an acoustic inspection scheme involves use of acoustic frequencies in an ultrasonic range of frequencies, such as including pulses having energy in a specified range that can include value from, for example, a few hundred kilohertz, to tens of megahertz, as an illustrative example.

### SUMMARY OF THE DISCLOSURE

Acoustic testing, such as ultrasound-based inspection, can include use of individual transducers, or arrays of such transducers including providing focusing or beam-forming techniques to aid in construction of data plots or images representing a region of interest on or within a test specimen. Use of an array of ultrasound transducer elements can include use of a phased-array beamforming approach and can be referred to as Phased Array Ultrasound Testing (PAUT). For example, a delay-and-sum beamforming technique can be used such as including coherently summing time-domain representations of received acoustic signals from respective transducer elements or apertures. A Total Focusing Method (TFM) beamforming technique can be used where one or more elements in an array (or apertures defined by such elements) are used to transmit an acoustic pulse and other elements are used to receive scattered or reflected acoustic energy, and a matrix is constructed of time-series (e.g., A-Scan) representations corresponding to a sequence of transmit-receive cycles in which the transmissions are occurring from different elements (or corresponding apertures) in the array.

Such a TFM approach where A-scan data is obtained for each element in an array (or each defined aperture) can be referred to as a “full matrix capture” (FMC) technique. In a manner similar to TFM imaging, a phase-based approach can be used for one or more of acquisition, storage, or subsequent analysis. Such a phase-based approach can include coherent summation of normalized or quantized representations of A-Scan data corresponding to phase information. Such an approach can be referred to as a “phase coherence imaging” (PCI) beamforming technique.

An inspection probe for PAUT testing comprises multiple piezoelectric elements. In imaging where Total Focusing Method (TFM) beamforming is used, acquisition of acoustic signals through an FMC (Full Matrix Capture) approach uses many physical transmission channels (e.g., one channel per element). For large-scale probe configurations (e.g., linear or matrix probe configurations), such as having 64 elements or 128 elements, a complexity of wiring or interconnects can present various challenges including that such a configuration is complex and costly to produce and may be heavy or cumbersome. Such an approach can also cause electromagnetic compatibility challenges, because dozens or hundreds of analog signals for both transmission and reception are carried by point-to-point wiring (internally within the probe assembly) or multi-conductor cable.

The present inventor has recognized, among other things, that a compressive sensing-based technique can be used to reduce a count of channels needed to collect analog signals from a multi-element PAUT probe, such as with a Plane Wave Imaging (PWI) acquisition approach where multiple elements are excited contemporaneously for transmission. Such an approach makes it possible to considerably simplify the hardware architecture of instrumentation, such as reducing complexity of wiring of the probe assembly or related interconnects. A portion or an entirety of an analog front end (AFE) can be embedded in the probe itself. Use of the present teachings can include reconstruction of received signals corresponding to the individual elements of the probe, with as few as a single analog channel used for receiving. As an example, as few as a single pulser can be used in transmission and as few as single analog-to-digital converter (ADC) can be used in reception.

In an example, a machine-implemented method can be used for performing acoustic inspection, the machine-implemented method comprising, for a sequence of different codes, generating an acoustic transmission from multiple elements of an acoustic transducer array contemporaneously. In response to the acoustic transmission, acoustic echo signals can be received from a subset of elements in the acoustic transducer array selected according to a code amongst the sequence of different codes. The received acoustic echo signals can be summed, such as in the analog domain, to provide a summed acoustic echo signal corresponding to the code. A full matrix of time-series acoustic acquisitions can be synthesized, corresponding to a greater count of elements in the acoustic transducer array than a count of the different codes, using summed acoustic echo signals corresponding to the different codes. For example, a compressive sensing approach can be used for such synthesis. Delay-and-sum beamforming can be performed using the synthesized full matrix of time-series acoustic acquisitions, such as to generate an image in support of acoustic inspection.

This summary is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates generally an example comprising an acoustic inspection system, such as can be used to perform at least a portion one or more techniques as shown and described herein.

FIG. 2A and FIG. 2B illustrate generally portions of an acoustic inspection system, such as where a multi-channel analog bus is used for transmission of pulses to acoustic transducer elements (as shown in FIG. 2A) or reception of analog electrical signals (as shown in FIG. 2B) from the acoustic transducer elements, or both.

FIG. 3A and FIG. 3B illustrate generally portions of an acoustic inspection system, such as where a reduced channel count is used for conveying pulses to acoustic transducer elements (as shown in FIG. 3A) or for reception of analog electrical signals (as shown in FIG. 3B) from the acoustic transducer elements, or both, such as for performing acoustic acquisition in relation to a compressive sensing approach.

FIG. 4A and FIG. 4B illustrate generally portions of an acoustic inspection system, similar to FIG. 3A and FIG. 3B, where a reduced channel count is used for conveying pulses to acoustic transducer elements (as shown in FIG. 3A) and for reception of analog electrical signals (as shown in FIG. 3B) from the acoustic transducer elements, such as for performing acoustic acquisition in relation to a compressive sensing approach.

FIG. 5 illustrates generally a workflow for performing beamforming, such as using a Total Focusing Method (TFM), to generate an image by performing delay-and-sum (e.g., coherent summation) on Full Matrix Capture (FMC) data that is reconstructed using a compressive sensing approach, based on acquisitions performed using a count M different code sequences corresponding to M unique codes.

FIG. 6A illustrates generally a coordinate system used for simulation, the coordinate system defining a location and configuration of a probe array, a region of interest (ROI), and a defect comprising a single side-drilled hole (SDH).

FIG. 6B illustrates generally an image generated by simulating application of a Total Focusing Method for beamforming from simulated Full Matrix Capture (FMC) data, where a compressive sensing technique has not been used.

FIG. 6C illustrates generally an image generated by simulating application of a Total Focusing Method for beamforming from simulated Full Matrix Capture (FMC) data, where the FMC data is constructed using a compressive sensing technique, corresponding to an acoustic acquisition where a count of M acquisitions were made, and the count M is less than a count of elements in the acoustic inspection probe array, Nₑ=128.

FIG. 7 illustrates generally a block diagram showing functional elements of a commercial analog front end (AFE) device, DCT042 (available from D-Clue Technology, Japan), that can be used to implement an acquisition approach for a compressive sensing technique as shown and described in this document.

FIG. 8A illustrates generally a coordinate system used for simulation, the coordinate system defining a location and configuration of a probe array, a region of interest (ROI), and defects comprising a side-drilled holes.

FIG. 8B illustrates generally an image generated by simulating application of a Total Focusing Method for beamforming from simulated Full Matrix Capture (FMC) data, where a compressive sensing technique.

FIG. 8C illustrates generally an image generated by simulating application of a Total Focusing Method for beamforming from simulated Full Matrix Capture (FMC) data, where the FMC data is constructed using a compressive sensing technique, corresponding to an acoustic acquisition where a count of M acquisitions were made, and the count M is less than a count of elements in the acoustic inspection probe array, Nₑ=128, and using a data flow as shown by the block diagram of FIG. 7.

FIG. 9 illustrates generally a technique, such as a machine-implemented method, for performing image generation using time-series data constructed using a compressive sensing technique, corresponding to an acoustic acquisition where a count of M acquisitions are made, and the count M is less than a count of elements in the acoustic inspection probe array used for acquisition.

FIG. 10 illustrates a block diagram of an example comprising a machine upon which any one or more of the techniques (e.g., methodologies) discussed herein may be performed.

### DETAILED DESCRIPTION

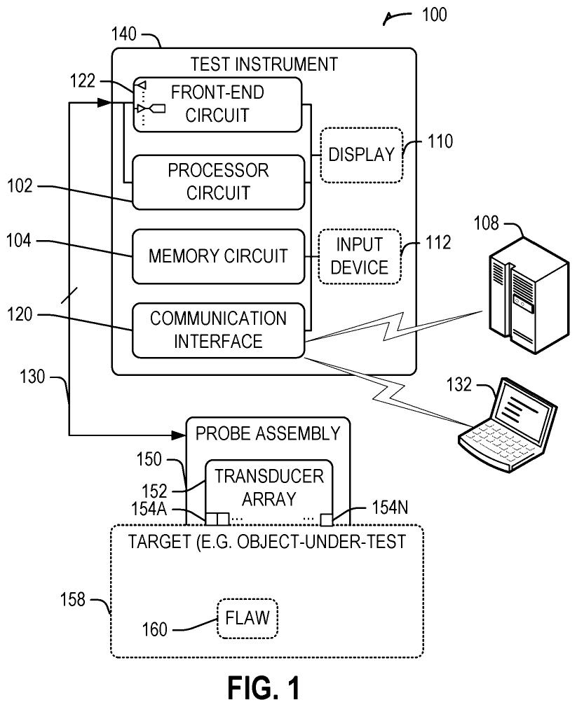

FIG. 1 illustrates generally an example comprising an acoustic inspection system 100, such as can be used to perform at least a portion one or more techniques as shown and described herein. The inspection system 100 can include a test instrument 140, such as a hand-held or portable assembly. The test instrument 140 can be electrically coupled to a probe assembly 150, such as using a multi-conductor interconnect 130. The probe assembly 150 can include one or more electroacoustic transducers, such as a transducer array 152 including respective transducers 154A through 154N. The transducers array can follow a linear or curved contour or can include an array of elements extending in two axes, such as providing a matrix of transducer elements. Element size and pitch can be varied according to the inspection application.

A modular probe assembly 150 configuration can be used, such as to allow a test instrument 140 to be used with various different probe assemblies. Generally, the transducer array 152 includes piezoelectric transducers, such as can be acoustically coupled to a target 158 (e.g., a test specimen or “object-under-test”) through a coupling medium 156. The coupling medium can include a fluid or gel or a solid membrane (e.g., an elastomer or other polymer material), or a combination of fluid, gel, or solid structures. For example, an acoustic transducer assembly can include a transducer array coupled to a wedge structure comprising a rigid thermoset polymer having known acoustic propagation characteristics (for example, Rexolite® available from C-Lec Plastics Inc.), and water can be injected between the wedge and the structure under test as a coupling medium 156 during testing, or testing can be conducted with an interface between the probe assembly 150 and the target 158 otherwise immersed in a coupling medium.

The test instrument 140 can include digital and analog circuitry, such as a front-end circuit 122 including one or more transmit signal chains, receive signal chains, or switching circuitry (e.g., transmit/receive switching circuitry). The transmit signal chain can include amplifier and filter circuitry, such as to provide transmit pulses for delivery through an interconnect 130 to a probe assembly 150 for insonification of the target 158, such as to image or otherwise detect a flaw 160 on or within the target 158 structure by receiving scattered or reflected acoustic energy elicited in response to the insonification. As shown and described elsewhere in this document, some or all of the front-end circuit 122 (or other portions of the system 100) can be located in the probe assembly 150, such as where a compressive sensing approach is used to reduce a count of signal channels carried by the interconnect 130. As an illustrative example, a phase-array probe assembly 150 could provide a self-contained hand-held system without requiring a bulky separate test instrument 140, or the test instrument 140 could house fewer components.

While FIG. 1 shows a single probe assembly 150 and a single transducer array 152, other configurations can be used, such as multiple probe assemblies connected to a single test instrument 140, or multiple transducer arrays 152 used with a single probe assembly 150 or multiple probe assemblies for pitch/catch inspection modes. Similarly, a test protocol can be performed using coordination between multiple test instruments 140, such as in response to an overall test scheme established from a master test instrument 140 or established by another remote system such as a compute facility 108 or general-purpose computing device such as a laptop 132, tablet, smart-phone, desktop computer, or the like. The test scheme may be established according to a published standard or regulatory requirement and may be performed upon initial fabrication or on a recurring basis for ongoing surveillance, as illustrative examples.

The receive signal chain of the front-end circuit 122 can include one or more filters or amplifier circuits, along with an analog-to-digital conversion facility, such as to digitize echo signals received using the probe assembly 150. Digitization can be performed coherently, such as to provide multiple channels of digitized data aligned or referenced to each other in time or phase. The front-end circuit can be coupled to and controlled by one or more processor circuits, such as a processor circuit 102 included as a portion of the test instrument 140. The processor circuit can be coupled to a memory circuit 104, such as to execute instructions that cause the test instrument 140 to perform one or more of acoustic transmission, acoustic acquisition, processing, or storage of data relating to an acoustic inspection, or to otherwise perform techniques as shown and described herein. The test instrument 140 can be communicatively coupled to other portions of the system 100, such as using a wired or wireless communication interface 120.

For example, performance of one or more techniques as shown and described herein can be accomplished on-board the test instrument 140 or using other processing or storage facilities such as using a compute facility 108 or a general-purpose computing device such as a laptop 132, tablet, smart-phone, desktop computer, or the like. For example, processing tasks that would be undesirably slow if performed on-board the test instrument 140 or beyond the capabilities of the test instrument 140 can be performed remotely (e.g., on a separate system), such as in response to a request from the test instrument 140. Similarly, storage of imaging data or intermediate data such as A-scan matrices of time-series data or other representations of such data, for example, can be accomplished using remote facilities communicatively coupled to the test instrument 140. The test instrument can include a display 110, such as for presentation of configuration information or results, and an input device 112 such as including one or more of a keyboard, trackball, function keys or soft keys, mouse-interface, touch-screen, stylus, or the like, for receiving operator commands, configuration information, or responses to queries.

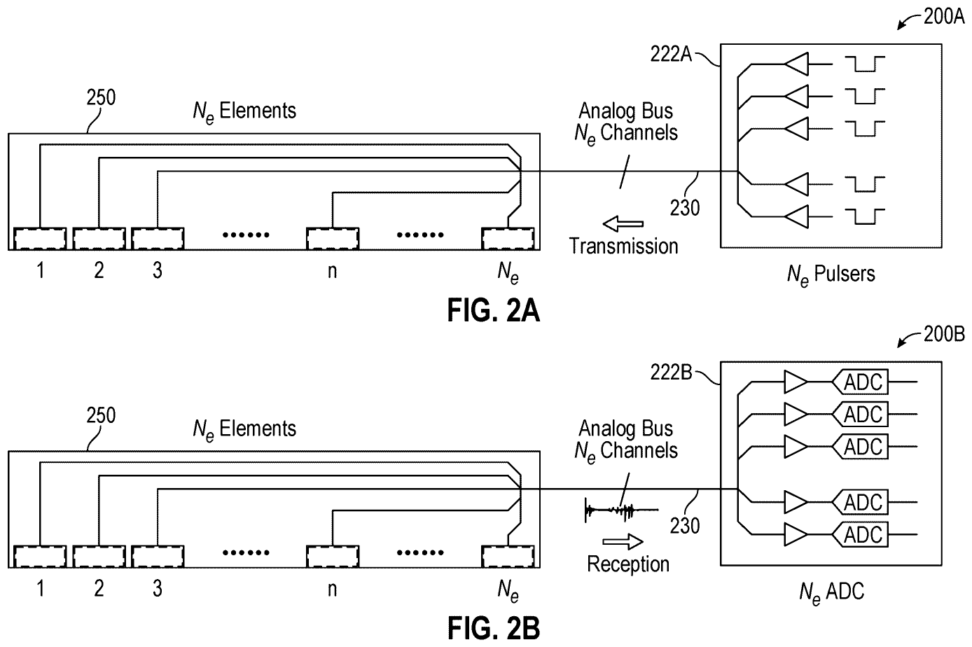

FIG. 2A and FIG. 2B illustrate generally portions of an acoustic inspection system, such as where a multi-channel analog bus is used for transmission of pulses to acoustic transducer elements (as shown in the example 200A of FIG. 2A) or reception of analog electrical signals (as shown in the example 200B FIG. 2B) from the acoustic transducer elements, or both. The approach shown for the transmission of example 200A includes exciting elements 1, 2, 3, . . . , n, . . . through Nₑ using an analog bus 230 where each element 1 through Nₑ has a corresponding channel in the analog bus 230, coupling a probe assembly 250 to transmission circuitry 222A of a test instrument separate from the probe assembly 250, such as including respective transmission pulse generator circuits (“pulsers”), where a count Nₑ of such pulsers is present to provide individual addressability of each of the elements 1, 2, 3, . . . , n, . . . through Nₑ. Similarly, in the receiving context of example 200B, each of the elements 1, 2, 3, . . . , n, . . . through Nₑ in the probe assembly 250 can use the analog bus 230 to transmit an analog representation of received signals to corresponding receiving channels in receiver circuitry 222B of the test instrument.

The receiver circuitry 222B generally includes signal conditioning and analog-to-digital converter (ADC) circuitry dedicated to each of the elements 1, 2, 3, . . . , n, . . . through Nₑ, so a count Nₑ of such ADCs is used. FIG. 2A and FIG. 2B show the complexity of interconnection, signal generation, and signal receiving circuitry. For example, for a probe assembly 250 configured for phased array ultrasonic testing (PAUT), the analog bus 230 may have dozens or even hundreds of physical conductors corresponding to each of the elements 1, 2, 3, . . . , n, . . . through Nₑ. As an illustration, an acquisition using an FMC approach produces many signals that each are generally digitized individually to produce time-series data, on the order of Nₑ×Nₑ×Nₛ, where Nₑ is a count of elements in the acoustic array and Nₛ corresponds to a count of time samples.

An increase in the count of elements in a PAUT probe is a trend observed in the NDT field. A new generation of matrix probes, which allow three-dimensional acquisition, may integrate several hundred elements. In such a context, wiring techniques can be a limiting factor, such as those corresponding to the analog bus 230 of FIG. 2A and FIG. 2B. As channel count increases, interconnections between the probe assembly 250 and the test instrument become heavier, more expensive, more fragile, and more cumbersome.

Such complexity can also be a limitation to the productivity and the ability of an acoustic inspection system to produce images at high rate. One approach to increase the productivity is to use a PWI (Plane Wave Imaging) acquisition, which generally performs one firing sequence, e.g., where all of the Nₑ elements are fired contemporaneously (or an aperture corresponding to multiple elements are fired contemporaneously). The received signals are then collected from each of the Nₑ elements individually and stored to produce a matrix of time-series data, referred to as an FMC approach. The present inventor has recognized that a compressive sensing (CS) approach can be implemented along with a modified transmission and receiving approach. Generally, a CS-based approach can be used to reduce a count of channels needed to collect analog signals from a multi-element probe assembly. Such a modified approach can include use of contemporaneous transmission of pulses from multiple elements, in a manner similar to PWI.

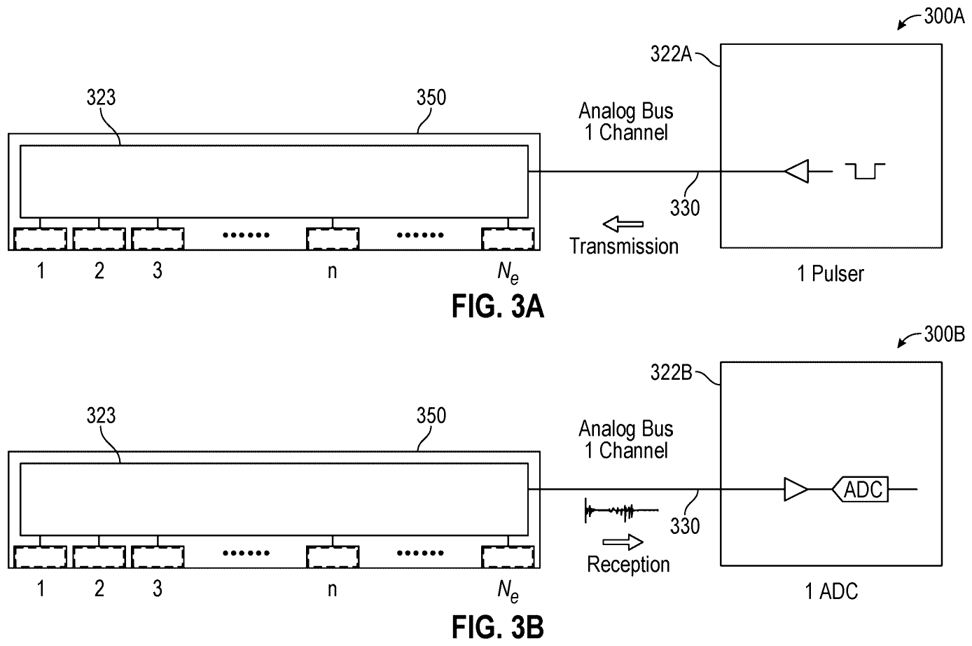

FIG. 3A and FIG. 3B illustrate generally portions of an acoustic inspection system, such as where a reduced channel count is used for conveying pulses to acoustic transducer elements (as shown in the example 300A of FIG. 3A) or for reception of analog electrical signals (as shown in the example 300B of FIG. 3B) from the acoustic transducer elements, or both, such as for performing acoustic acquisition in relation to a CS-based approach. As an illustration, in the transmission context, as shown in the example 300A of FIG. 3A, as few as a single transmit pulse signal generator can be used (as shown in the transmission circuitry 322A of a test instrument), so an interconnection 330 need only carry as a few as single channel to probe assembly circuitry 323 included as a portion of the probe assembly 350. For example, the probe assembly circuitry 323 can provide switching or signal conditioning so that a generated signal from the transmission circuitry 322A is routed to elements 1, 2, 3, . . . , n, . . . through Nₑ for contemporaneous acoustic transmission from multiple elements.

Similarly, in the receiving context of example 300B, for a respective transmit event, and in response to an acoustic transmission, received acoustic echo signals from a selected subset of elements 1, 2, 3, . . . , n, . . . through Nₑ in the probe assembly 350 can be summed together (e.g., in the analog domain), and as few as single summed acoustic echo signal can be transmitted over the interconnection 330, such as for digitization by as few as a single analog-to-digital conversion (ADC) circuit. The approach of contemporaneous transmission from multiple elements and summation of received signals makes it possible to considerably simplify the hardware architecture of an analog front-end of a test instrument, as well as the wiring of the probe assembly 350. As described in various examples below, individual time-series acoustic signals can be constructed from the summed representations to establish a set of time-series data equivalent to a full matrix capture (FMC) acquisition performed using plane-wave imaging (PWI) transmission.

Generally, a PWI acquisition procedure can include contemporaneous firing of Nₑ elements and then parallel acquisition of Nₑ resulting acoustic echo signals. The received signals are generally collected from all the Nₑ individual elements and can be then gathered in a matrix Y_{N}_{_{e×N}}ₛ of dimension Nₑ×Nₛ (e.g., a “full matrix capture” or FMC acquisition). The value of Nₛ represents a count of time samples for one acquisition of one echo signal. A Delay-and-Sum (DAS) approach generally used to reconstruct an image. Such an approach can be referred to as a “Total Focusing Method” beamforming approach, where focal laws used for delay values are established on pixel-by-pixel or voxel-by-voxel basis and coherent summations are performed on time-series A-scan data for each receiving element to establish a pixel or voxel value in an image. As shown and described herein, a compressive sensing approach can include forming an estimated matrix of time-series data Ŷ_{N}_{_{e×N}}ₛ, that is equivalent to the Y_{N}_{_{e×N}}ₛ matrix, but is constructed using far fewer receive acquisitions, M, than a count of Nₑ elements. Using this approach, a full matrix of time-series acoustic acquisitions can be synthesized, corresponding to a greater count of elements (e.g., Nₑ) than a count of the different codes and corresponding acquisitions, (e.g., M).T

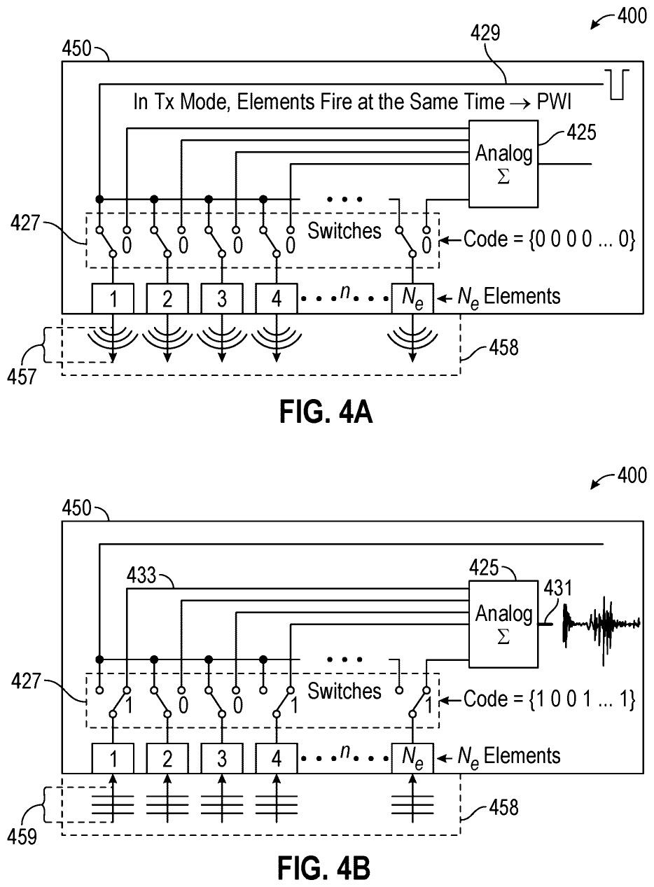

As an illustration of an acquisition approach used for compressive sensing, FIG. 4A and FIG. 4B illustrate generally portions of an acoustic inspection system 400, similar to the examples 300A of FIGS. 3A and 300B of FIG. 3B, where a reduced channel count is used for conveying pulses to acoustic transducer elements 1, 2, 3, . . . , n, . . . through Nₑ and for reception of analog electrical signals from the acoustic transducer elements 1, 2, 3, . . . , n, . . . through Nₑ. As shown in FIG. 4A, a single transmission can be conveyed to a transmit bus 429 of an acoustic inspection probe assembly 450, such as routed using switching circuit 427 to excite multiple acoustic elements contemporaneously (e.g., firing all at once in PWI transmission mode into an object under test 458).

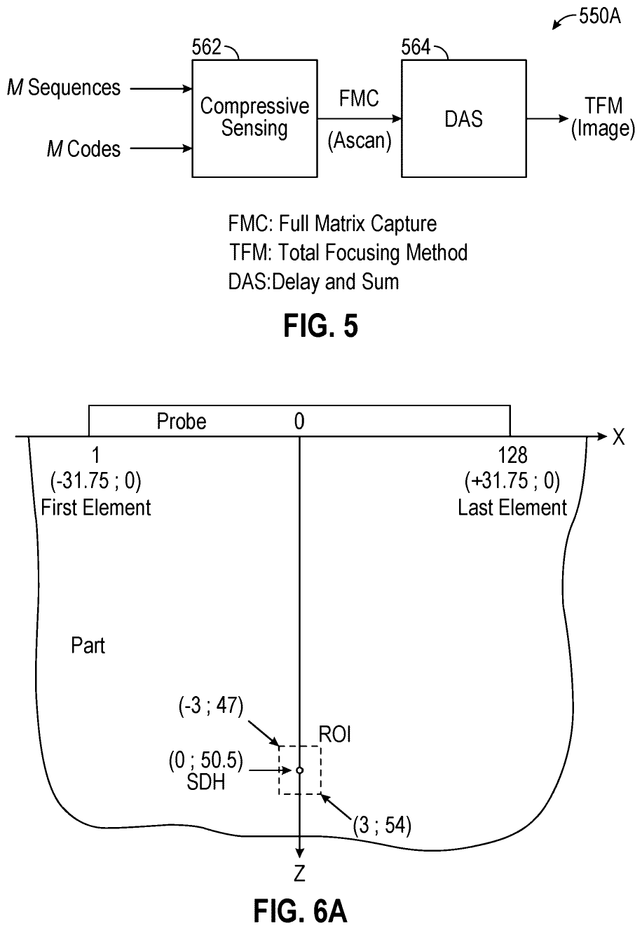

In this transmission mode, an analog summing circuit 425 can be isolated by the switching circuit 427 from the transmission conveyed on the transmit bus 429. In response to the acoustic energy 457 transmitted by the transducer elements 1, 2, 3, . . . , n, . . . through Nₑ, reflected or scattered acoustic energy 459 can be received as shown in FIG. 4B. For example, the switching circuit 427 can change state to connect selected ones of the transducer elements 1, 2, 3, . . . , n, . . . , Nₑ to respective inputs 433 to the analog summing circuit 425, and an output 431 can provide a summed representation of the received acoustic signal (e.g., in the analog domain, without delay values applied for beamforming or focusing). A state of the switching circuit 427 can be established according to a code. The code can define a series of binary-valued digits, where a count of digits corresponds to the count Nₑ of transducer elements. A value of one in a respective digit results in a corresponding transducer element being connected to the analog summing circuit 425 by the switching circuit 427, and a zero in a respective digit de-selects an element, suppressing a contribution from the element corresponding to the digit containing the zero (or vice versa). In a compressive sensing approach, a series of acquisitions can be performed using the transmission configuration shown in FIG. 4A (e.g., where all elements fire contemporaneously), and a series of different receive configurations corresponding to different codes applied to the switching circuit 427, as shown for one code value illustratively in FIG. 4B. In generally, the compressive sensing approach can follow a scheme as shown in FIG. 5. For example, a count of M transmit events can be performed (e.g., where multiple elements fire contemporaneously), and a count of M different codes can be used to control which transducer elements are active for receiving and summing with a unique code used for receiving after each corresponding transmit event (e.g., for one acquisition amongst the M acquisitions, all elements fire, and a specified subset of elements receive, set by the code). At 562, a compressive sensing approach as shown and discussed below can be performed to construct an equivalent FMC matrix of time-series acquisitions corresponding to A-scans, and at 564, a Delay-and-Sum beamforming approach can be used to generate an image (such as using a Total Focusing Method to establish delay values).

In general, as discussed above, only some transducer elements are selected as active during receiving, with such selection made by each different code in the sequence of M codes. For a respective code value, corresponding received signals are summed together (e.g., in the analog domain) to form a summed received signal bₙ(t) (corresponding to an “n-th” element) which can be transmitted elsewhere using a single channel and digitized (or digitized on-board the probe assembly). The code values are randomly generated such as defined by a combinatorial logic system (e.g., a linear-feedback shift register or other approach such as to generate a pseudo-random sequence). After the sequence of M codes has been used for the M transmit events, a digital record can be established corresponding to the M received acoustic signals, b₁ (t) to b_{M} (t).

All the data acquired and sampled can be gathered in a matrix

$${B}_{M \times {N}_{s}} = {[ {b}_{1}^{T} ( k ) , {b}_{2}^{T} ( k ) , … , {b}_{M}^{T} ( k ) ]}^{T} ,$$

of dimension M×Nₛ, where Nₛ is the count of time samples of one signal bₙ (t). Generally, using this acquisition approach, the acquired receive signal data can be transmitted on as few channels as a single channel and with a count of transmission events M that is lower than the count of Nₑ transducer elements, e.g., M<<Nₑ.

For the analytical discussion below, respective random code values used for selecting the receive elements can be represented as Rx1 to RxNₑ and can be placed in matrix form represented by a random weighting matrix φ_{M×N}_{ₑ}, of dimension M×Nₑ. A normal FMC data acquisition (where receive element signals are digitized individually) can be represented by a matrix Y_{N}_{ₑ}_{×N}_{ₛ}, as would have been obtained with a PWI acquisition without use of the CS approach described herein. An estimated matrix Ŷ_{N}_{ₑ}_{×N}_{ₛ}, that is equivalent to the matrix Y_{N}_{ₑ}_{×N}_{ₛ} can be constructed using the compressive sensing approach from the measurements grouped in the matrix B_{M×N}_{ₛ}. This estimation can be referred to as a “reconstruction” approach and can be defined by three phases: (1) establishing a hypothesis; (2) acquisition; and (3) estimation.

Establishing a hypothesis: the signals are assumed to be sparse in some other domain (e.g., a frequency domain) such as defined by a set of coefficients associated with basis functions. For example, received signals can be hypothesized to be sparse in a DCT (Discrete Cosine Transform) space. Accordingly, a matrix Y_{N}_{ₑ}_{×N}_{ₛ}, suitable for use in Delay-and-Sum beamforming to generate a TFM image can be obtained from the DCT coefficients (e.g., frequency-domain transform weights) gathered in a matrix H_{N}_{ₑ}_{×N}_{ₛ} as shown below in EQN. (1).

$${Y}_{{N}_{e} \times {N}_{s}} = {ψ}_{{N}_{e} \times {N}_{e}} \cdot {H}_{{N}_{e} \times {N}_{s}} \qquad EQN . ( 1 )$$

$$where$$

$${ψ}_{{N}_{e} \times {N}_{e}} = IDCT ( {I}_{{N}_{e} \times {N}_{e}} ) \qquad EQN . ( 2 )$$

represents an inverse sparse DCT matrix and I_{N}_{ₑ}_{×N}_{ₑ}, the identity matrix.

Because the signals are assumed to be sparse in DCT domain, only a few coefficients in the matrix H_{N}_{ₑ}_{×N}_{ₛ} are not equal to zero. This is an assumption that can define a compressive sensing technique. It should be noted that another domain could be used, such as wavelet or Fourier domains, for example, so the use of DCT is illustrative but non-limiting.

Acquisition: signal acquisition is performed as described elsewhere in this document, such as where a sequence of random codes are used to populate the matrix B_{M×N}_{ₛ}, and it can be assumed that the observed measurements forming the matrix B_{M×N}_{ₛ} can be equal to a product defined as the sequence of random codes (represented by random weighting matrix φ_{M×N}_{ₑ}) multiplied to the matrix Y_{N}_{ₑ}_{×N}_{ₛ}:

$${B}_{M \times {N}_{s}} = {ϕ}_{M \times {N}_{e}} \cdot {Y}_{{N}_{e} \times {N}_{s}} \qquad EQN . ( 3 )$$

with

$${B}_{M \times {N}_{s}} = {[ {b}_{1}^{T} ( k ) , {b}_{2}^{T} ( k ) , … , {b}_{M}^{T} ( k ) ]}^{T} \qquad EQN . ( 4 )$$

and φ_{M×N}_{ₑ} representing the matrix of random weights, comprising uniformly randomly distributed zero and one values, as discussed above.

Estimation: from EQN. (1) and EQN. (3) it can be shown that:

$${B}_{M \times {N}_{s}} = {A}_{M \times {N}_{e}} \cdot {H}_{{N}_{e} \times {N}_{s}} \qquad EQN . ( 5 )$$

$$where$$

$${A}_{M \times {N}_{e}} = {ϕ}_{M \times {N}_{e}} \cdot {ψ}_{{N}_{e} \times {N}_{e}} . \qquad EQN . ( 6 )$$

An L1 norm inversion procedure can be used to estimate the DCT coefficients:

$${\hat{H}}_{{N}_{e} \times {N}_{s}} = arg {min}_{h} {‖ {B}_{M \times {N}_{s}} - {A}_{M \times {N}_{e}} \cdot {H}_{{N}_{e} \times {N}_{s}} ‖}_{1} \qquad ( 7 )$$

The estimated DCT coefficients Ĥ_{N}_{ₑ}_{×N}_{ₛ} are then used to estimate the matrix Ŷ_{N}_{ₑ}_{×N}_{ₛ}:

$${\hat{Y}}_{{N}_{e} \times {N}_{s}} = {ψ}_{{N}_{e} \times {N}_{e}} \cdot {\hat{H}}_{{N}_{e} \times {N}_{s}} \qquad ( 8 )$$

Once the estimate Ŷ_{N}_{ₑ}_{×N}_{ₛ} is generated, corresponding to a matrix of A-scans equivalent to an FMC acquisition, beamforming can be performed using a DAS approach applied to the estimate Ŷ_{N}_{ₑ}_{×N}_{ₛ}, such as to generate an image using TFM. Simulation can be performed to demonstrate the efficacy of the compressive sensing technique.

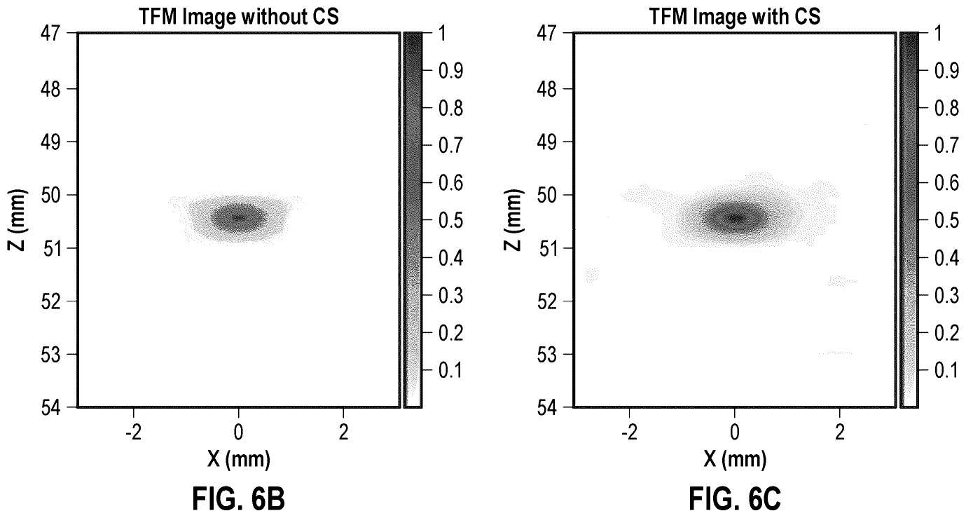

For example, FIG. 6A illustrates generally a coordinate system used for such simulation, the coordinate system defining a location and configuration of a probe array, a region of interest (ROI), and a defect comprising a single side-drilled hole (SDH). This example includes imaging the SDH in a steel object under test using a PAUT probe having 128 elements in contact with the object under test. The region of interest (ROI) for FIG. 6B and FIG. 6C is defined around the SDH. All dimensions of the configuration are shown in millimeters.

FIG. 6B illustrates generally an image generated by simulating application of a Total Focusing Method for beamforming from simulated Full Matrix Capture (FMC) data, where a compressive sensing technique has not been used and FIG. 6C illustrates generally an image generated by simulating application of a Total Focusing Method for beamforming from simulated Full Matrix Capture (FMC) data, where the FMC data is constructed using a compressive sensing technique, corresponding to an acoustic acquisition where a count of M acquisitions were made, and the count Mis less than a count of elements in the acoustic inspection probe array, Nₑ=128. The grid resolution in both FIG. 6B and FIG. 6C is 0.02 mm and M=16, corresponding to a compression ratio, CR=128/16=8.

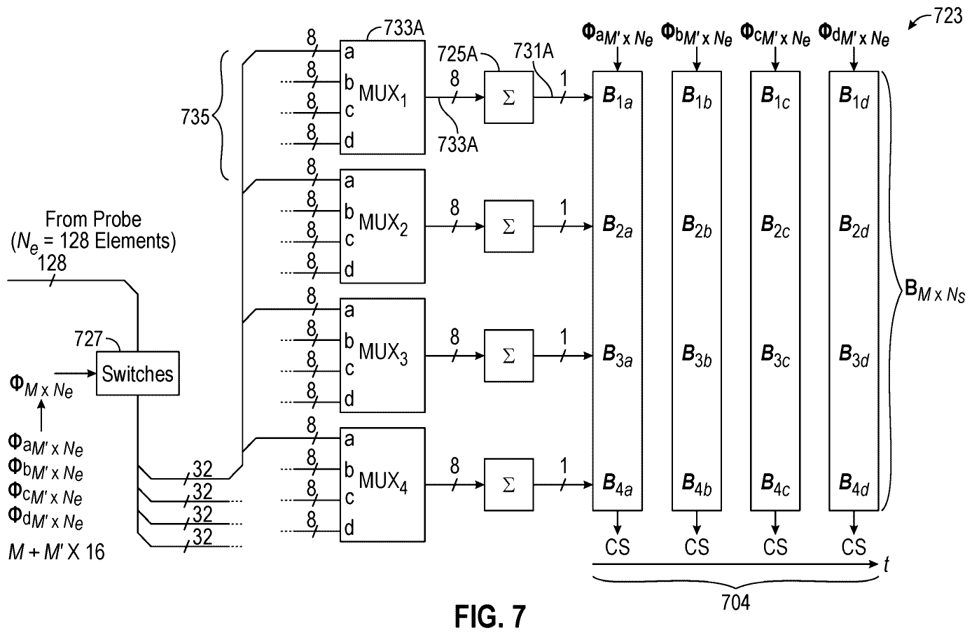

FIG. 7 illustrates generally a block diagram showing functional elements of a commercial analog front-end (AFE) circuit 723, DCT042 (available from D-Clue Technology, Japan), that can be used to implement an acquisition approach for a compressive sensing technique as shown and described in this document. The AFE circuit 723 can be used as part of a probe architecture having on-board electronics. In this example, the AFE circuit 723 is a low power transceiver with 32-channel transmitter and receiver that can be connected to 128 ultrasonic elements. The layout allows a transmit and receive functions on a single chip and can be used for small hand-held ultrasound systems. In this approach, the transmitter can drive 32 ultrasound elements contemporaneously, and such elements can form an aperture selected from 128 elements, as an illustrative example. The receiver is compactly arranged in functional blocks, such as a block 735. Switching circuitry 727 can be used to select receive elements, and such selected elements can be fed into a multiplexer 733A, which is then routed to a summing circuit 725A, and an output 731A of the summing circuit can be digitized and routed to a memory circuit 704 shown as organized in FIG. 7. Generally, the architecture of the AFE circuit 723 of FIG. 7 can receive 32 channels contemporaneously, summing the channels in groups of 8 channels, selected from 128 elements by the switching circuitry 727. A configuration as shown in FIG. 7 can use four analog-to-digital conversion circuits (one corresponding to each block similar to block 735). From 128 transducer elements included in a probe assembly, switching sequences for the switching circuitry 727 are determined by the matrix φ of random codes, and resulting acquisition data are merged and sequenced in time to give the B matrices that can be used for the compressive sensing approach (including construction of the estimate Ŷ_{N}_{ₑ}_{×N}_{ₛ}) as discussed above.

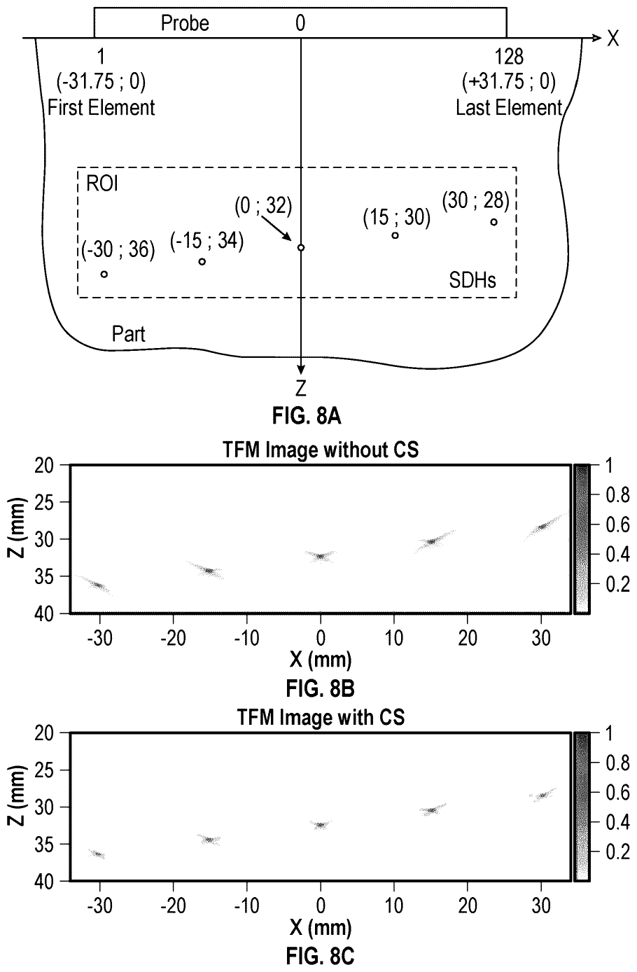

The architecture of the AFE circuit 723 of FIG. 7 can also be used to generate simulated imaging results for comparison to FMC acquisition without compressive sensing. For example, FIG. 8A illustrates generally a coordinate system used for simulation, the coordinate system defining a location and configuration of a probe array, a region of interest (ROI), and defects comprising side-drilled holes. The coordinate system of FIG. 8A shows an ROI encompassing five SDHs in a steel object under test, with dimensions provided in millimeters.

FIG. 8B illustrates generally an image generated by simulating application of a Total Focusing Method for beamforming from simulated Full Matrix Capture (FMC) data, where a compressive sensing technique has not been used, and FIG. 8C illustrates generally an image generated by simulating application of a Total Focusing Method for beamforming from simulated Full Matrix Capture (FMC) data, where the FMC data is constructed using a compressive sensing technique, corresponding to an acoustic acquisition where a count of M acquisitions were made, and the count Mis less than a count of elements in the acoustic inspection probe array, Nₑ=128. The grid resolution in FIG. 8B and FIG. 8C is 0.05 mm. In FIG. 8C, M=M′×Nₘᵤₓ×N_{ch}, with Nₘᵤₓ=4 (a count of multiplexing channels, e.g., four multiplexers similar to the multiplexer 733A shown in FIG. 7), and N_{ch}=4 (a count of output channels, e.g., with each output similar to the output 731A shown in FIG. 7). The compressive sensing approach processes data 8 by 8, M′ is in the range of 8 (no compression) to 1:1≤M′≤8. In this example, M′=4, corresponding to a compression ratio, CR=128/(4×4×4)=2. In this example, a count of M′ acquisitions (transmit events and corresponding receive acquisitions) are used.

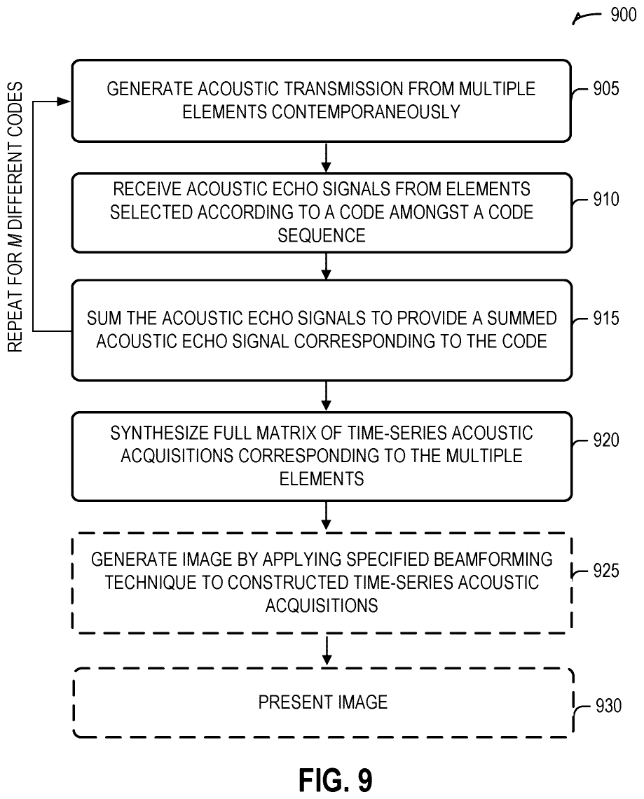

FIG. 9 illustrates generally a technique 900, such as a machine-implemented method, for performing image generation using time-series data constructed using a compressive sensing technique, corresponding to an acoustic acquisition where a count of M acquisitions are made, and the count M is less than a count of elements in the acoustic inspection probe array used for acquisition. For M different random codes, an acquisition can be performed. The acquisition can include, at 905, generating an acoustic transmission from multiple elements contemporaneously. This could include all elements in an array of acoustic transducers, or a specified aperture comprising multiple elements, but not necessarily all elements.

At 910, in response to the acoustic transmission, acoustic echo signals can be received from elements selected according to a code amongst the M different random codes. At 915, the acoustic echo signals received at 910 can be summed (such as in the analog domain), to provide a summed acoustic echo signal corresponding to the selected code. The operations at 905, 910, and 915 can be repeated for the M different codes, and at 920, an equivalent full matrix of time-series acoustic acquisitions can be synthesized as shown and described above, using a compressive sensing approach. At 925, an image can be generated by applying a specified beamforming technique to construct time-series acoustic acquisitions, such as by using receive focal laws to establish delay values (or correspond phase rotations), and then coherent summing the constructed time-series acoustic acquisitions to establish a pixel or voxel value. Such summations can be performed for different locations in a region of interest, and at 930, an image can be presented to a user. For example, TFM beamforming can be used.

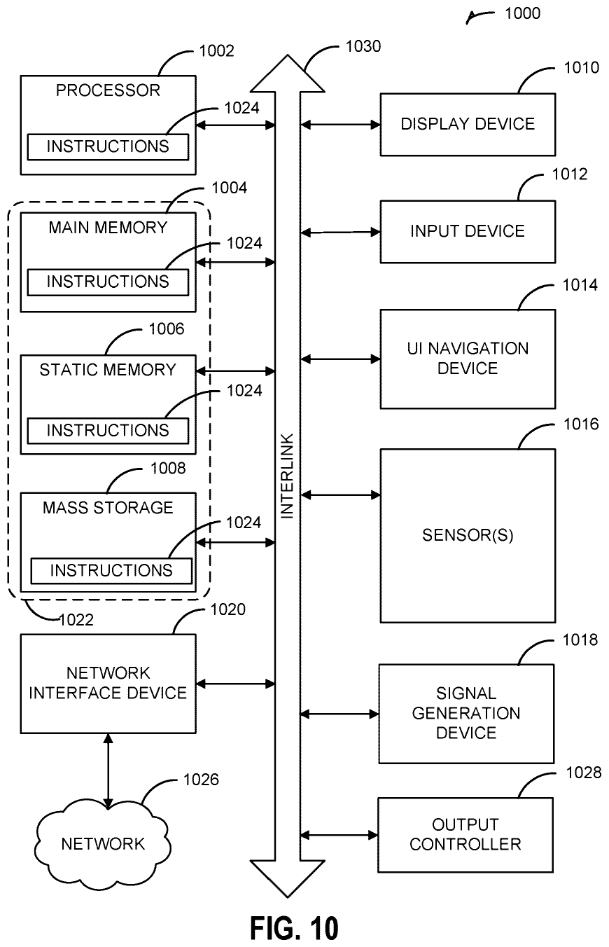

FIG. 10 illustrates a block diagram of an example comprising a machine 1000 upon which any one or more of the techniques (e.g., methodologies) discussed herein may be performed. Machine 1000 (e.g., computer system) may include a hardware processor 1002 (e.g., a central processing unit (CPU), a graphics processing unit (GPU), a hardware processor core, or any combination thereof), a main memory 1004 and a static memory 1006, connected via an interlink 1030 (e.g., link or bus), as some or all of these components may constitute hardware for systems or related implementations discussed above.

Generally, the hardware processor 1002 may, for example, include at least one of a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), a Tensor Processing Unit (TPU), a Neural Processing Unit (NPU), a Vision Processing Unit (VPU), a Machine Learning Accelerator, an Artificial Intelligence Accelerator, an Application Specific Integrated Circuit (ASIC), a Field Programmable Gate Array (FPGA), a Radio-Frequency Integrated Circuit (RFIC), a Neuromorphic Processor, a Quantum Processor, or any combination thereof. A processor circuit may further be a multi-core processor having two or more independent processors (sometimes referred to as “cores”) that may execute instructions contemporaneously. Multi-core processors contain multiple computational cores on a single integrated circuit die, each of which can independently execute program instructions in parallel. Parallel processing on multi-core processors may be implemented via architectures like superscalar, VLIW, vector processing, or SIMD that allow each core to run separate instruction streams concurrently. A processor circuit may be emulated in software, running on a physical processor, as a virtual processor or virtual circuit. The virtual processor may behave like an independent processor but is implemented in software rather than hardware.

Specific examples of main memory 1004 include Random Access Memory (RAM), and semiconductor memory devices, which may include storage locations in semiconductors such as registers. Specific examples of static memory 1006 include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; RAM; or optical media such as CD-ROM and DVD-ROM disks.

The machine 1000 may further include a display device 1010, an input device 1012 (e.g., a keyboard), and a user interface (UI) navigation device 1014 (e.g., a mouse). In an example, the display device 1010, input device 1012, and UI navigation device 1014 may be a touch-screen display. The machine 1000 may include a mass storage device 1008 (e.g., drive unit), a signal generation device 1018 (e.g., a speaker), a network interface device 1020, and one or more sensors 1016, such as a global positioning system (GPS) sensor, compass, accelerometer, or some other sensor. The machine 1000 may include an output controller 1028, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The mass storage device 1008 may comprise a machine-readable medium 1022 on which is stored one or more sets of data structures or instructions 1024 (e.g., software) embodying or utilized by any one or more of the techniques or functions described herein. The instructions 1024 may also reside, completely or at least partially, within the main memory 1004, within static memory 1006, or within the hardware processor 1002 during execution thereof by the machine 1000. In an example, one or any combination of the hardware processor 1002, the main memory 1004, the static memory 1006, or the mass storage device 1008 comprises a machine readable medium.

Specific examples of machine-readable media include, one or more of non-volatile memory, such as semiconductor memory devices (e.g., EPROM or EEPROM) and flash memory devices; magnetic disks, such as internal hard disks and removable disks; magneto-optical disks; RAM; or optical media such as CD-ROM and DVD-ROM disks. While the machine-readable medium is illustrated as a single medium, the term “machine readable medium” may include a single medium or multiple media (e.g., a centralized or distributed database, or associated caches and servers) configured to store the one or more instructions 1024.

An apparatus of the machine 1000 includes one or more of a hardware processor 1002 (e.g., a central processing unit (CPU), a graphics processing unit (GPU), a hardware processor core, or any combination thereof), a main memory 1004 and a static memory 1006, sensors 1016, network interface device 1020, antennas, a display device 1010, an input device 1012, a UI navigation device 1014, a mass storage device 1008, instructions 1024, a signal generation device 1018, or an output controller 1028. The apparatus may be configured to perform one or more of the methods or operations disclosed herein.

The term “machine readable medium” includes, for example, any medium that is capable of storing, encoding, or carrying instructions for execution by the machine 1000 and that cause the machine 1000 to perform any one or more of the techniques of the present disclosure or causes another apparatus or system to perform any one or more of the techniques, or that is capable of storing, encoding or carrying data structures used by or associated with such instructions. Non-limiting machine-readable medium examples include solid-state memories, optical media, or magnetic media. Specific examples of machine-readable media include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); or optical media such as CD-ROM and DVD-ROM disks. In some examples, machine readable media includes non-transitory machine-readable media. In some examples, machine readable media includes machine readable media that is not a transitory propagating signal.

The instructions 1024 may be transmitted or received, for example, over a communications network 1026 using a transmission medium via the network interface device 1020 utilizing any one of a number of transfer protocols (e.g., frame relay, internet protocol (IP), transmission control protocol (TCP), user datagram protocol (UDP), hypertext transfer protocol (HTTP), etc.). Example communication networks include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®), IEEE 802.15.4 family of standards, a Long Term Evolution (LTE) 4G or 5G family of standards, a Universal Mobile Telecommunications System (UMTS) family of standards, peer-to-peer (P2P) networks, satellite communication networks, among others.

In an example, the network interface device 1020 includes one or more physical jacks (e.g., Ethernet, coaxial, or other interconnection) or one or more antennas to access the communications network 1026. In an example, the network interface device 1020 includes one or more antennas to wirelessly communicate using at least one of single-input multiple-output (SIMO), multiple-input multiple-output (MIMO), or multiple-input single-output (MISO) techniques. In some examples, the network interface device 1020 wirelessly communicates using Multiple User MIMO techniques. The term “transmission medium” shall be taken to include any intangible medium that is capable of storing, encoding or carrying instructions for execution by the machine 1000, and includes digital or analog communications signals or other intangible medium to facilitate communication of such software.

### VARIOUS NOTES

Each of the non-limiting aspects above can stand on its own or can be combined in various permutations or combinations with one or more of the other aspects or other subject matter described in this document.

The above detailed description includes references to the accompanying drawings, which form a part of the detailed description. The drawings show, by way of illustration, specific embodiments in which the invention can be practiced. These embodiments are also referred to generally as “examples.” Such examples can include elements in addition to those shown or described. However, the present inventor also contemplates examples in which only those elements shown or described are provided. Moreover, the present inventor also contemplates examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc., are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Such instructions can be read and executed by one or more processors to enable performance of operations comprising a method, for example. The instructions are in any suitable form, such as but not limited to source code, compiled code, interpreted code, executable code, static code, dynamic code, and the like. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A machine-implemented method for performing acoustic inspection, the machine-implemented method comprising:
for a sequence of different codes:
generating an acoustic transmission from multiple elements of an acoustic transducer array contemporaneously;
in response to the acoustic transmission, receiving acoustic echo signals from a subset of elements in the acoustic transducer array selected according to a code amongst the sequence of different codes; and
summing the received acoustic echo signals to provide a summed acoustic echo signal corresponding to the code; and
synthesizing a full matrix of time-series acoustic acquisitions corresponding to a greater count of elements in the acoustic transducer array than a count of the different codes, using summed acoustic echo signals corresponding to the different codes.

2. The machine-implemented method of claim 1, wherein the generating the acoustic transmission from multiple elements comprises generating an acoustic transmission from all of the elements in the acoustic transducer array contemporaneously.

3. The machine-implemented method of claim 1, wherein the synthesized time-series acoustic acquisitions correspond to A-scan time-series data; and
wherein the machine-implemented method comprises comprising generating an image using a delay-and-sum beamforming technique using the synthesized full matrix of time-series acoustic acquisitions.

4. The machine-implemented method of claim 1, wherein the sequence of different codes comprises a sequence of randomly-generated codes.

5. The machine-implemented method of claim 4, wherein the codes comprise a specified count of binary-valued digits corresponding to a count of elements in the acoustic transducer array; and
wherein a distribution of ones and zeroes in the binary-valued digits is uniform.

6. The machine-implemented method of claim 5, wherein the subset of selected elements corresponds to ones in the binary-valued digits, with deselected elements corresponding to zeroes in the binary-valued digits, or vice versa.

7. The machine-implemented method of claim 1, wherein the synthesizing the full matrix of time-series acoustic acquisitions comprises performing a compressive sensing (CS) technique including estimating weighting coefficients in a sparse matrix of frequency-domain transform weights and multiplying an inverse of a sparse frequency domain transform of an identity matrix by the estimated weights to provide the full matrix of time-series acoustic acquisitions.

8. The machine-implemented method of claim 7, wherein the frequency-domain transform comprises a discrete cosine transform (DCT).

9. The machine-implemented method of claim 1, wherein the summing the received acoustic echo signals comprises summing the received signals in an analog domain.

10. The machine-implemented method of claim 9, wherein the summed received acoustic signals are digitized using a single analog-to-digital conversion channel.

11. The machine-implemented method of claim 9, wherein the summing the received signals in the analog domain is performed using circuitry on or within an inspection probe assembly housing the acoustic transducer array.

12. The machine-implemented method of claim 9, wherein the receiving acoustic echo signals from the subset of elements in the acoustic transducer array selected according to the code amongst a sequence of different codes comprises establishing a state of switching circuitry coupling the elements to an analog summing circuit.

13. The machine-implemented method of claim 9, wherein the summed received acoustic signals are transmitted to another circuit separate from an inspection probe assembly housing the acoustic transducer array.

14. The machine-implemented method of claim 9, wherein a single pulser channel is used to generate the acoustic transmission.

15. A system for performing acoustic inspection, the system comprising:
an acoustic transducer array;
a transmission pulser circuit;
a receiver circuit comprising an analog-to-digital converter circuit;
a processor circuit; and
a memory circuit communicatively coupled with the processor circuit, the memory circuit comprising instructions that when executed by the processor circuit cause the system to perform a machine-implemented method, comprising:
for a sequence of different codes:
generating an acoustic transmission from multiple elements of an acoustic transducer array contemporaneously;
in response to the acoustic transmission, receiving acoustic echo signals from a subset of elements in the acoustic transducer array selected according to a code amongst the sequence of different codes; and
summing the received acoustic echo signals to provide a summed acoustic echo signal corresponding to the code; and
synthesizing a full matrix of time-series acoustic acquisitions corresponding to a greater count of elements in the acoustic transducer array than a count of the different codes, using summed acoustic echo signals corresponding to the different codes.

16. The system of claim 15, comprising an analog summing circuit configured to provide a summed acoustic echo signal representing a sum of received acoustic echo signals, the summed acoustic echo signal corresponding to a code used to select a subset of elements in the acoustic transducer array.

17. The system of claim 16, comprising switching circuitry configured to select the subset of elements using a state corresponding to the code.

18. The system of claim 17, wherein the acoustic transducer array, the analog summing circuit, and the switching circuitry are included as a portion of an inspection probe assembly.

19. The system of claim 15, further comprising an inspection instrument separate from an acoustic inspection probe assembly;
wherein processor circuit and the memory circuit are included as a portion of the inspection instrument.

20. A system for performing acoustic inspection, the system comprising:
for a sequence of different codes:
a means for generating an acoustic transmission from multiple elements of an acoustic transducer array contemporaneously;
in response to the acoustic transmission, a means for receiving acoustic echo signals from a subset of elements in the acoustic transducer array selected according to a code amongst the sequence of different codes; and
a means for summing the received acoustic echo signals to provide a summed acoustic echo signal corresponding to the code; and
a means synthesizing a full matrix of time-series acoustic acquisitions corresponding to a greater count of elements in the acoustic transducer array than a count of the different codes, using summed acoustic echo signals corresponding to the different codes.
